(19) United States
(12) Patent Application Publication
(10) Pub. No.: US 2007/0209524 A1
(43) Pub. Date: Sep. 13, 2007

(54) A MACHINE INTERFACED COFFEE PODS INCLUDING O-RING AND A BREWING METHOD THEREOF

(76) Inventor: Fijeau Kim, Seoul (KR)

Correspondence Address: IPLA P.A., 3580 WILSHIRE BLVD., 17TH FLOOR, LOS ANGELES, CA, 90010, US

(21) Appl. No.: 10/599,853

(22) PCT Filed: Apr. 11, 2005
(86) PCT No.: PCT/KR05/01032

§ 371 Date: Oct. 11, 2006

(30) Foreign Application Priority Data
Apr. 13, 2004 (KR) 10-2004-0025543
Mar. 31, 2005 (KR) 10-2005-0027007

(51) Int. Cl. A47J 31/00

(52) U.S. Cl. 99/295

(57) ABSTRACT

The present invention provides pod easy to package a variety of soluble contents and simple to extract them. The pod includes an o-ring inserted between two sheets of rectangular packaging means, and is formed to be three dimensional shape by attaching upper and lower portions of the side margins defined by the inserted o-ring. Also, a mechanical interfacing means is provided at side margins of the pod to thereby mechanically interfacing and converting the pod and connecting one or several pods side by side so that they can be extracted mechanically by means of an extraction device corresponding to the mechanically interfaced and converted pod. In addition, according to the pod, it is possible to completely extract the content contained in the pod by using mechanical position recognition, automatic opening after position change, and extraction mechanism of the content. Further, there is provided an extracting method for the pod, and an extraction device using the method.

### TECHNICAL FIELD

The present invention relates to packaging a pack, which is solved into water and can be extracted or reduced with water vapor and hot water, and an extraction method thereof.

The present invention also relates to a pod which packages and seals contents in predetermined volumes and weights with an o-ring between two sheets of packaging means. Further, this invention relates to an extraction mechanism and extraction device using the mechanism, in which mechanically interfacing means is formed at sides margins of the pod, and which is comprised of one pod or several pods connected side by side at full length, where the extraction mechanism extracts contents packaged in the pod through controlling the pod mechanically by means of using the movement and opening mechanism of the pod.

### BACKGROUND ART

The content packaged in the pod is generally beverage foods that can be solved into water and extracted and reduced with water vapor and hot water, and the content is maintained in the pod and extracted. Especially, coffee is one of the typical foods can be packed in the pod, and a great number of people in the world drink coffee that is one of the enjoyable foods.

Nowadays, one of the most generally used way of extracting and drinking coffee is to flow hot water to the lower direction by gravity and extract coffee, after placing roasted and ground coffee on a coffee drip filter having an inverted triangular conical shape. It is so called brew a coffee.

However, this coffee brewing method is very inconvenient to brewers because it needs lots of labors exerted on treating before extraction and in sanitary, discard of the remainders after extraction, and the like. Accordingly, it is attempted to simply extract coffee by way of sealing in one dose unit packaging means such as coffee pod, capsule, or a cartridge. Especially, it is attempted to commercially use an extraction method in which the roasted and ground coffee is sealed and packaged in an aluminum or plastic capsule by predetermined volume for one dose use, and broken the packaging means to extract before use.

The shortcomings of the extraction device, which employs opening methods of the packaging means that includes a disposable receptacle or a capsule distributed in the market and the like, are as follows. That is, it is difficult to maintain cleanliness of the extraction device because it is inconvenient to clean interior portions thereof due to complexity of the structure of the extraction devices. Further, it is required to employ relatively dangerous punching or cutting means in the opening process of the packaging means due to its thickness so that it is necessary to treat materials used in packaging minutely if the opening process is to be repeated accurately, making the manufacturing of the extraction device complex and increasing the price of the produced extraction device. Accordingly, the features of the materials used in the receptacle and opening position of the receptacle and the like may be burdensome on designing the extraction device for the packaging, transporting, injecting, opening and extracting process of the content in the receptacle.

Owing to the captioned shortcomings of the extraction device, it is increasingly attempted to make use of the method of packaging content in pod, which is relatively simple to pack and use, and very economic. Further, roasted and ground coffee is distributed and sold in the market, which is being packaged in the filter paper sheet in one dose unit as a simple and round shaped pod, however, it is difficult to mechanize or automate the extraction system using the form of conventional pod and repeat the process of coffee extraction due to the simplicity of the conventional coffee pod.

### DISCLOSURE OF INVENTION

Accordingly, the present invention has been made to solve the above-mentioned problems occurring in the prior art, and it is an object of the present invention to provide packaging pack, which can be solved into water and can be extracted or reduced with water vapor and hot water, and extraction method thereof.

Also, another object of the present invention is to provide the pod which packages and seals contents in predetermined volumes and weights with an o-ring between two sheets of packaging means.

To achieve the above objects, according to the present invention, there is provided a pod 10 that is to be packaged between two sheets of packaging means, and which is related to packaging of contents that includes water soluble and extractable materials such as roasted and ground coffee (hereinafter, the content 30 is explained in view of coffee, and the ground coffee means a general coffee). In the present invention, a mechanical interfacing device 50 is formed at the side margins 51 of the pod 10 (hereinafter, a pod 10 means coffee pod in a broad sense, unless there is any special description) made by “n” unit pods connected at full length side by side, each of which is packaged in the packaging means 12, to thereby mechanically interfacing and converting the pod.

Further, there is provided an extraction mechanism that can be repeated to result in the same effects from the extraction mechanism of the extraction device 90, and in which the captioned mechanically interfaced and converted pod is opened by means of an opening means set forth below.

In the present invention, the content of the pod 10 can be extracted with water vapor or hot water so that the pod 10 can be employed in packaging, depositing, transporting and extracting of the reducible foods.

### BRIEF DESCRIPTION OF DRAWINGS

FIG. 1 is an exploded view of a pod 10 for showing an o-ring 20 inserted between two sheets of packaging means;

FIG. 2a is a view for showing several pods 10 with rectangular shape connected side by side and linear cutting line 57 being formed at connections thereof;

FIG. 2b is a view for showing several pods 10 with rectangular shape and “U” shaped cutting line being formed at connections thereof;

FIG. 3a is a view for showing movement of the pod 10 by way of guidance of a slide with engaging the ring 71 into a mechanical interfacing device 50 formed at pod 10, which is ready for next step;

FIG. 3b is a view for showing movement of the pod 10 progressively with riding on a rotation shaft 75, the mechanical interfacing device 50 being engaged into a ring;

FIGS. 4a and 4b are views for showing unoccupied cavity, cavity occupied with pod 10, and upper and lower cavities equipped with orifices 93.

### BEST MODE FOR CARRYING OUT THE INVENTION

The present invention will hereinafter be described in further detail with reference to the drawings in which preferred embodiments of the present invention are described. It will however be obvious to a person skilled in the art that the present invention is not limited to or by the embodiments.

Hereinafter, the shape, structure, function and action of a pod 10, together with an explanation of a mechanical interfacing device 50 will be described by beginning to define “terms” used in the specification, to an explanation of an extraction device and function thereof.

Pod (Will be Described with Focusing on Packaging Means)

A pod represents for shell or husk of peas and the like in a dictionary meaning. However, a pod 10 of this invention includes a form of structure packaging content 30 in the middle of two packaging means 12, and means formed at the structure form, and combination and action of the functions produced from the fore-mentioned means.

Packaging Means Constituting the Pod

The packaging means 12 represents for a packaging material composed of flat sheet, and is composed of insulating materials having the property of impermeableness to oxygen and fluids. The content 30 contained in the packaging means 12 is conglomerated into forms of tablet to result in being packaged in the middle of the packaging means 12. Upper and lower portions of the content 30 are wrapped and sealed by the packaging means 12 so that insoluble solids of the content will be remained in the packaging means and the extracted liquids produced by the injected hot water into the pod 10 at the time of extracting the content 30 will be discharged to the outside.

O-Ring as Supporting Means for the Packaging Means

As described above, the outer shape of the packaging means consisted of relatively thin and flexible film can be squeezed at a limited range or deformed from the initial shape by means of physical forces exerted from the outside. Accordingly, an O-ring 20 can be inserted in the packaging means 12 as supporting means so that the outer shape and size of the pod 10 are maintained uniformly and tightly.

In general, the o-ring 20 is shaped to be a donuts form or a finger ring form, and equipped with size values of height, inner diameter and outer diameter to thereby defining a three dimensional space in the inner diameter portion.

The pod 10 is shaped to be three dimensional cubic form by covering and sealing the outer diameter portion of the o-ring 20 with the packaging means 12, and at the same time the o-ring supports the pod 10 physically with its height and outer diameter to result in making the shapes of all the pods 10 to be identical, so that the volume of the pod 10 corresponds to the volume of the o-ring 20 and the height of the pod 10 corresponds to the height of the o-ring 20, and the standard of the position, shape and the outer form is maintained to be identical for respective pod 10 according to the shape of the o-ring 20.

Accordingly, for the mechanical extraction device in which same shaped pods 10 are provided to make the conditions identical, in case of the change of the shape and size of the pods 10, same conditions for the extraction and opening of the pods 10 cannot be provided. In other words, in case of a mechanical extraction device with an extracting means 90 that continuously extracts the same content and is equipped with cavity 91, the inner shape of the cavity 91 of the extraction means may coincide with the outer shape of the pod 10.

Therefore, when the pod 10 is extracted by the mechanical extraction device, the outer shape and size of the pod 10 should correspond to the inner shape of the cavity 91 of the extracting means 90 so as to extract content identically. Especially, the diameter, height and outer margins of the pod packaging the content 30 may correspond to the inner shape of the cavity 91 of the extracting means 90 in the mechanical extraction device, and also the pod can be located suitably in inside of the same cavity 91 only if the pod is uniformly supplied so that the pod can be sealed simultaneously with the mounting to repeat the extraction of the content accurately in order of opening the pod by way of the opening means, extraction by way of the extracting means 90, and disposal process without any errors.

To satisfy the fore-mentioned conditions of the operation of the present extraction device, an o-ring 20 is inserted in the middle of the pod 10, which is provided with a height and diameter defining sufficient volume to fill the center of the pod 10 with content 30;

An outer shape of the pod 10 is maintained uniformly by using physical strength of the o-ring 20 to coincide with inner side of the cavity 91 thereby maintaining the sealed state at the time of extraction;

When extract the pod 10, the o-ring 20 evenly maintains the height of the cavity 91 so that opening means in the cavity 91 can be inserted into the pod 10 with an accurate depth due to o-ring 20;

The o-ring 20 functions to have the outer packaging means 12 protect content 30 from being deformed by way of outer forces at the time of extraction;

The opening means can be operated accurately on a punching position of the pod 10.

As the contents 30 are filled in the space formed by the inner diameter of the o-ring 20, the size of the o-ring 20 is made to coincide with the volume of content 30 required.

The overall shape of the o-ring 20 can be formed to be a cut shape of pipe, a donuts shape, and the like, which is selected freely depending on the intended objects. Simultaneously, side cut shape of the o-ring 20 can be freely formed to be round shape, rectangular shape, pentagonal shape, hexagonal shape, octagonal shape and the like, with reference to the center axis of the o-ring 20.

The material of the o-ring 20 is plastic or elastic polymer having elasticity and physical strength, which can endure forces applied and can perform the process, when the extracting means 90 open the pod 10 to perform the process or the extracting means 90 is pressed to seal the surroundings of the pod 10. Such material of the o-ring 20 is well known in the relevant field of art, so detailed description thereof is omitted as it is different from the subject invention.

The height of the o-ring 20 is in a range of 2˜50 mm, preferably in a range of 5˜20 mm, and the diameter can be freely chosen to be in a range of 10˜50 mm. Also, the thickness of the o-ring 20 can be defined in a range of 0.5˜10 mm so that it can maintain physical strength enduring pressure applied by the corresponding extraction device.

Side Margins 51

Side margins 51 represents for an element of the packaging means 12 surrounding the central circular portion, which covers the o-ring 20 with the packaging means 12 and is attached to each other at upper and lower portions thereof. The side margins 51 makes the o-ring 20 protruded as upper and lower portions of the packaging means are attached. Therefore, the side margins can package surroundings of the content 30 to make the shape of the pod 10.

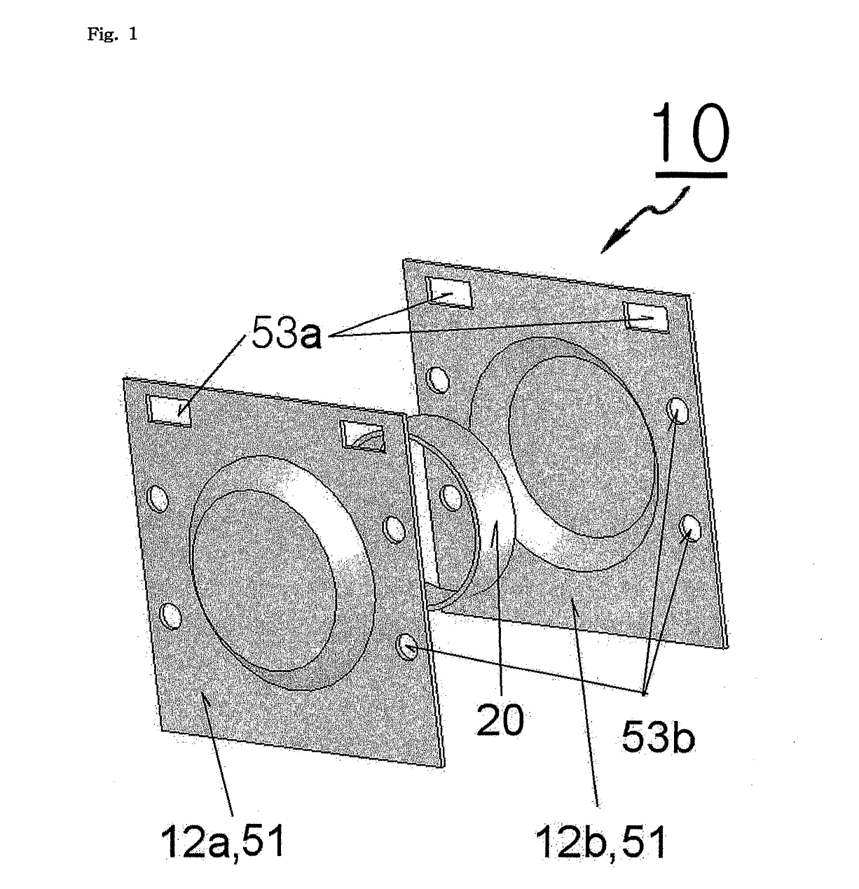

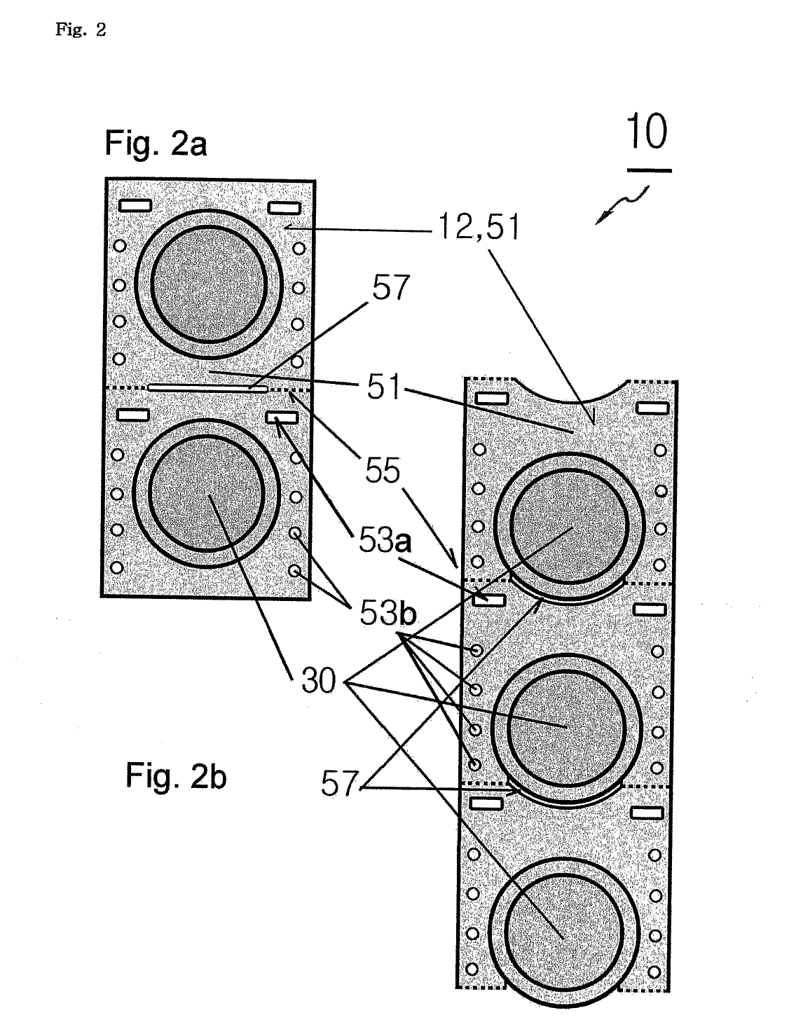

In the pod 10 of the subject invention, as shown in FIGS. 1 and 2, the side margins 51 provides three-dimensional form of the pod 10 by attaching upper and lower portions of the sides in the o-ring 20 with two sheets of packaging means 12a, 12b, thereby packaging and sealing upper and lower portions and side portions of the o-ring 20. At the same time, the side margins 51 provide space for a mechanical interfacing means 50 to be formed.

Materials of the Packaging Means

The materials of the packaging means 12 should have insulation functions. Especially, they should have impermeable features to oxygen and fluids, and have strength enduring the high pressure vapor or hot water (in particular, fluid pressure and temperature in a range of 1˜20 atm and almost 90° C. in case of espresso coffee) injected from outside at the time of extraction of the content 30. Accordingly, it is possible to deposit the content 30 at sealed state for the periods until use without separate pouch and with only packaging means 12 of the present invention, whereas conventional coffee pod is being packaged by filter paper and with additional out package of pouch made of impermeable material and distributed in the market.

The material of the packaging means 12 is selected from the materials that may have relatively strong strength enough to maintain the state of the content 30 contained in the pod 10. Also, it is selected from the materials that may have tensile strength enough to endure pressure of the hot water and cannot be broken, when the hot water is injected from the injection orifice 93 to the cavity 91 formed at the extracting means 90.

That is, the material of the packaging means 12 is selected from the group consisted of such plastic materials as LDPE (low density polyethylene), HDPE (high density polyethylene), PP (polypropylene), PS (polystyrene), ABS resin, PC (polycarbonate), polyester, PET complex resin, EVOH (ethylene vinyl alcohol), PVDC (polyvinylidene chloride) and the like, which are the materials of low oxygen permeability or fluids impermeability, and in which the glass transition temperature or softening temperature of the material is above the boiling temperature of 100° C., or they are selected in consideration of the features of the multi-layer complex sheet such as multi-layer plastic sheet, especially, metallic thin film (aluminium, stainless and the like)/plastic.

The packaging means 12 is made of any material selected from the above group, and has the thickness enough to endure overcoming strength of the content in a range of 0.01˜2 mm, preferably in a range of 0.02˜1.5 mm, more preferably 0.03˜1.0 mm.

As described above, the pod 10 of the present invention comprises the packaging means 12, the o-ring 20, side margins 51, and the mechanical interfacing means 50, and hereinafter the construction and action of the pod 10 will be explained more concretely as follows.
The o-ring 20 is inserted between the packaging means 12,
The side margins 51 formed at two sheets of the packaging means 12, which is located at upper and lower portions of the o-ring, are attached so that the o-ring 20 containing the content 30 protrude to make the pod 10 to be three dimensional shape,
The packaging means 12 packages the content 30 in a sealed state through attaching the side margins 51, and supports all the shape of the pod 10 three dimensionally,
The side margins 51 provide space to form the mechanical interfacing means 50 so that the pod 10 is mechanically interfaced,
The content 30 to be extracted by vapor or hot water is adapted to be contained in the space formed at center of the o-ring 20,
The packaging means 12 is made of complex materials including flexible plastic or metal, which are impermeable to fluids, to conserve the state of the content 30 by means of sealing the packaging means 12,
The content 30 can be extracted by the extraction device equipped with extracting means corresponding to the pod 10 of the present invention.

The pod 10 of the present invention includes the contained content 30, opening means and forming of the mechanical interfacing means, and conferring of the action and functions thereof. Accordingly, this invention provides a system for extracting and discarding, moving and loading content 30 using the mechanical interfacing means 50 formed at side margins 51 of the pod 10 in the course of packaging, transporting, opening, extracting, and discarding process of the content 30 contained in the pod 10.

The coffee, one of the content 30 packaged in the pod 10, is obtained through roasting and grinding the green bean to a desired size depending on the property of the drinks to be objected.

The volume and size of the pod 10 can be varied based on the volume required for the packaging of the content 30 to be contained in the O-ring 20.

In case of the roasted and ground coffee, it is required for 4˜10 g of roasted and ground coffee to extract a cup of coffee. As the bulk density of the less compressed roasted coffee is almost in a range of 0.4˜0.7 g/cc, it is required for the coffee pod 10 to have inner volume of approximately in a range of 5˜25 cc to extract one or two cups of coffee.

Nowadays, the conventional coffee pod distributed widely in the market can be classified into several kinds. In the pod, roasted and ground coffee, which has a volume of approximately in a range of 5˜15 g, is packaged in the filter paper with shapes of round pie having respective size of 44 mm, 55 mm, and 62 mm, and the height of the pod is almost 10 mm to make it possible to extract one or two cups of drinks, especially coffee.

Accordingly, it is necessary for the diameter of the content 30 contained in the o-ring 20 to be in a range of 30˜70 mm and the height of the contents 30 to be in a range of 5˜30 mm so as to maintain the similarity to the conventional products.

The content 30 contained in the o-ring 20 is packaged into a piece to constitute one pod 10, or they are supplied to the space defined between two sheets of the packaging means 12 continuously, because the tapes to be packaged by the same length, same distance, and same shape result in connected several pods 10 at full length.

The pod 10 of the present invention is characterized by comprising a mechanical interfacing means 50 formed at the side margins 51 thereof except for the portions wrapping the o-ring 20. The pod 10 of the present invention is made by sealing upper and lower portions of the content 30 contained in the o-ring 20 by the packaging means 12. They are packaged in a piece or connected side by side in uniform shape so that they are used in the extraction device corresponding to the mechanical interfacing means. Further, a mechanically interfacing means 50 is provided at side margins 51 of the pod to make them mechanically converted.

Mechanical Interfacing Means 50

In case of extracting the pod 10 of the present invention, the content 30 thereof is extracted by the extraction device equipped with extraction function corresponds to the pod 10, and the mechanical functions of the extraction device are to recognize the position and existence of the pod 10, to remove the pod 10, to open the pod 10, to extract the pod 10, to initialize the pod after discarding, and the like as follows.
Recognition means for sensing and measuring, and recognition mechanism employing same;
A ring 71 of the transporting portion, a slide 73 or a rotation shaft 75 and moving mechanism employing the transporting part;
Opening of the pod 10 by means of the opening means;
Extraction mechanism which extracts and discards the pod 10 progressively based on the command from the extraction part 90, and based on the cavity 91 of the extraction part 90 and boiler.

The mechanical interfacing means 50, which performs the additive function of adapting to the mechanical action of the extraction device, is provided at side margins 51 of the pod 10 so that the extraction device in exclusive use of the pod 10 operates to correspond to the pod 10.

The term “mechanical interfacing means 50” represents for an additive interface device formed at the pod 10 to correspond to the outer mechanical actions so that the extraction device can extract the content 30 by mechanically recognizing, moving, opening and controlling the pod 10 of the present invention. This is intended to make use of the functions of the interfacing means in response to the exclusive extraction device.

Several methods are considered to make use of the mechanical mechanism in combination with the pod 10 in the exclusive extraction device employing the above interfacing means.

Examples of mechanical interfacing means 50 applicable to pod 10 are listed as follows.

Recognition Mechanism in Mechanical Interfacing Means 50

The functions of the recognition part can be divided into “recognition” and “being recognized”. The recognition is performed when the mechanical interfacing means 50 reads the number of the pods 10, or signals emitted from the sensor or reader. This is intended that, after sensing the position of the pod 10, the recognition means provides the moving part with recognition information to make the moving mechanism to operate accurately in time. There are several methods for providing the recognition mechanism in the extraction device with information so that the exclusive extraction device can sense the state of the pod 10 at the time of extracting the pod 10. The mechanical interfacing means 50 are as follows.
Defining recognition hole 53b at pod 10 by punching side margins 51, where recognition hole 53b, one of the several functions given from the mechanical interfacing means 50, represents for a punched hole formed at side margins so that the punched hole can recognize distance for the pod 10 to move to an accurate position, and the recognition hole is a through-hole 53, which is made to sense accurate progressed distance by counting the number of the recognition hole 53b passed at the time of moving to an extraction position, and to move to a next position intended;
Forming certain shrinks at side margins 51,
Forming regular subsidence at side margins,
Attaching magnetic chips, magnetic tapes or magnetic bands regularly, which can be read by a reader,
Forming magnetic print or print mark at side margins 51 regularly, which can be read by a reader,
Attaching semiconductor chips regularly, which can be read by a reader,
Attaching function button regularly, which can be read by a reader.

The recognition mechanism represents for a mechanical interfacing means 50 applicable to movement of position and control.

Movement Mechanism in Mechanical Interfacing Means 50

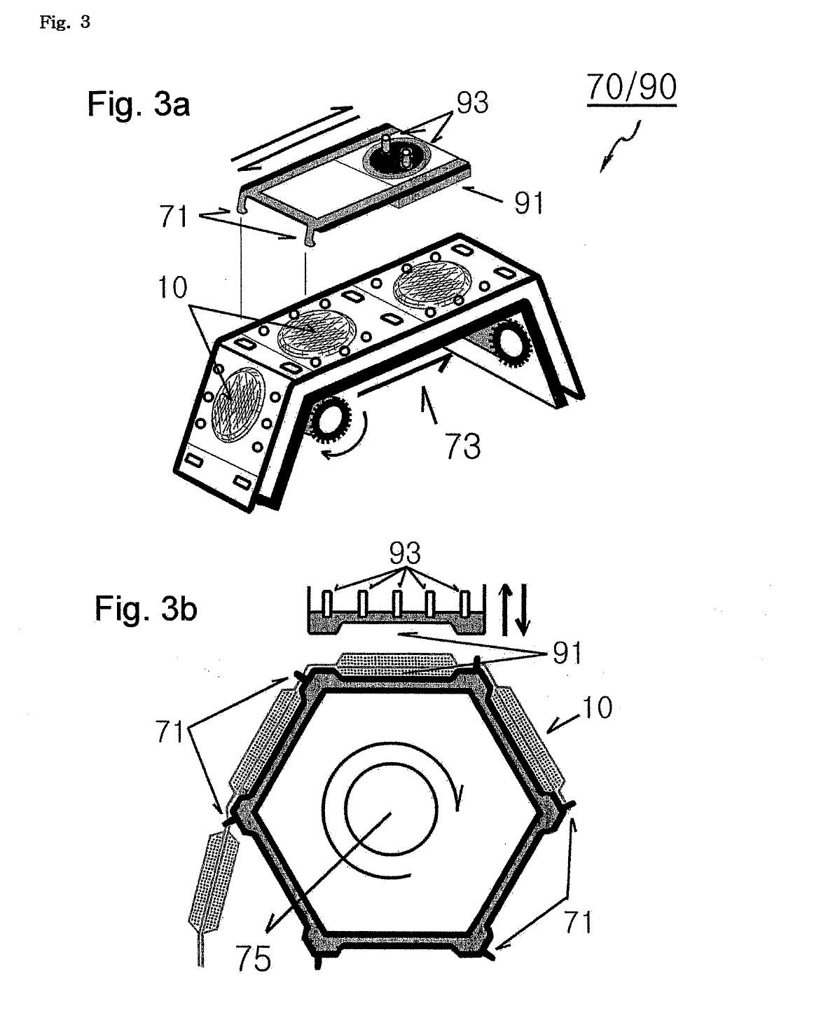

As the mechanical interfacing means 50, which can be formed at side margins 51 of the pod 10 and includes functions corresponding to the actions of the movement mechanism in order to move the pod 10 mechanically, a through hole 53 can be provided at side margins 51 of the pod 10 so that it functions as in photographic 35 mm film, where the through hole 53 can be utilized to take photographs at accurate positions and applies the position of film and automatic photographer mechanically. The through hole 53 can be formed in several shapes to control the movement operations. One of the through hole 53 is an engaging hole 53a for holding a ring 71 to hang and drag the pod 10 with the ring 71 of the movement mechanism as shown in FIGS. 2a, and 2b and 3a, and 3b, the other is an recognition hole 53b for measuring the position punched regularly at side margins 51 of the pod 10 with predetermined intervals.

The engaging hole 53a is formed at the same position for each pod 10 to make it easy for engaging with the ring 71 mechanically without errors. Also, the recognition hole 53b is formed regularly at side margins 51 of the pod 10 with predetermined distance so that they can be used in several objects including recognition mechanism and movement mechanism.

Further, like the mechanical interfacing means 50, forming shrinks at side margins 51, making subsidence at side margins 51, and forming regular ring 71 at side margins 51, can be also employed.

The movement mechanism represents for the mechanical interfacing means 50 employed in movement and control of the position.

Tear Off Line 55

In case of several pods 10 arranged side by side to make them be utilized in continuous automatic extraction device, the tear off line 55 represent for the temporary connection portion formed with small intervals or preliminarily torn off portion in dotted line so that it is possible to detach one pod 10, which is ready for extraction with being arranged at cavity of the extracting means, from the other pod 10, which is ready for extraction at outside of the extracting means, with small forces and to transport them to a desired position by a piece at each time of the extraction of the pod 10.

In side margins 51 of the packaging means 12 connecting the several pods 10, they are only attached at the tear off line 55, as shown in FIGS. 2a, and 2b, and the tensile strength of the tear off line is so strong as to endure the weights of the set of the pods 10 connected that they can not be detached at the time of packaging or movement of the set of pods.

The tear off line 55 is formed to be dotted line in the attached portions so that it can be separated easily by small forces.

Cutting Line 57

The cutting line 57 represents for a portion of the pod 10, where remainder portion of the pod except for the tear off line 55 has been already cut in the longitudinal direction so that the tear off line 55 can be easily detached. The cutting line 57 is completely cut in contrast to the tear off line 55 connected by dotted line.

Cutting Means

In case of the simple pod 10 in which the packaging means 12 is connected side by side except for the tear off line 55 and the cutting line 57, next process can be performed after cutting with the cutting means, especially cutter or knife and the like. The cutting means replaces the tear off line 55 or the cutting line 57.

As described above, it is possible to make use of the several types of mechanical interfacing means 50, however it is preferable to choose advantageous methods, in consideration of the production cost, easiness of the exclusive extraction device, and the potential mass production.

The movement part can comprise a ring 71 for hanging and dragging the engaging hole 53a of the pod 10, and the slide 73, that is, the moving means 70 for guiding the ring 71 to the next step or rotation shaft 75.

The ring 71 engages with the engaging hole 53a of the pod 10 to be introduced into the cavity 91 of the extracting means 90 with the movement means 70 so that the slide 73 can move forward and afterward or rotate by way of the rotation shaft 75 thereby initiating the process, and the ring 71 is separated after it moves to a discarding position when the extraction of the contents are completed, and then it moves to its original position to stand by a command for starting new step.

The slide 73 or the rotation shaft 75 operates to guide the pod 10 to move along the moving way formed by the ring 71 in a predetermined direction.

The moving mechanism introduces a plurality of pods 10, which are arranged side by side, into the extraction part 90 in sequence by way of engagement with the ring 71 and guidance of the slide 73 or the rotation shaft 75, and it comprises steps of moving the pod to the discarding position and starting position after extraction.

Opening Mechanism in Mechanical Interfacing Means

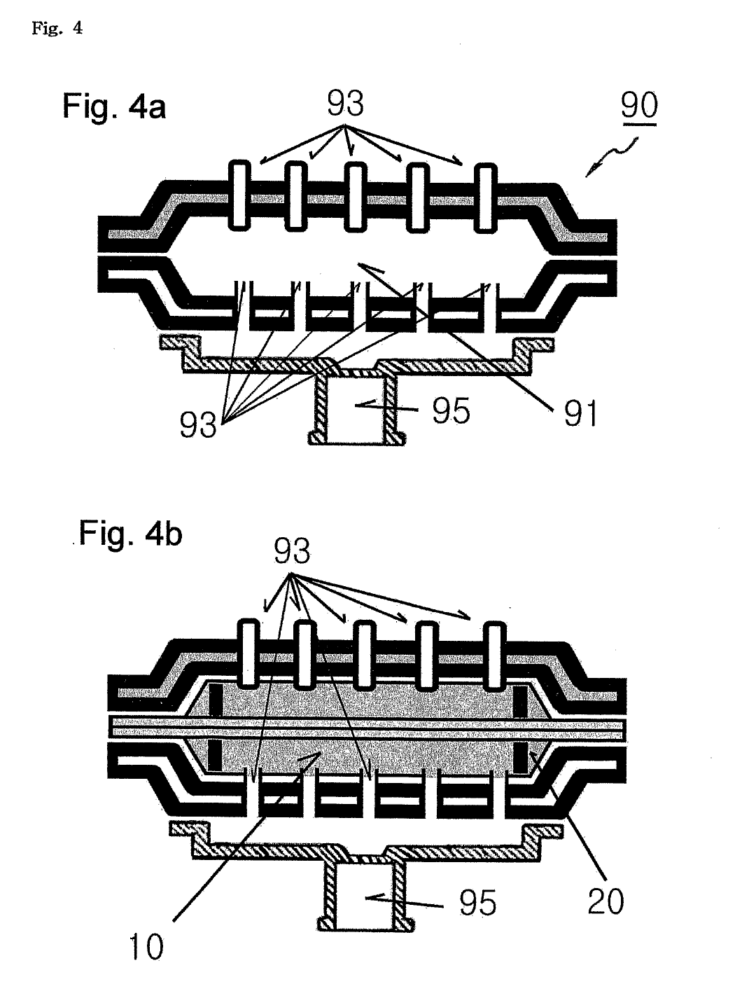

As shown in FIGS. 4a, and 4b, orifices 93 are formed at upper and lower portions of the cavity 91 in the extracting means 90. The orifices 93 are shaped in the form of needles to punch and open the packaging means 12 minutely by focusing on the periphery of the o-ring 20. The packaging means 12 is attached to the o-ring 20 tightly to support the pod from the inner side, and it is formed to be predetermined height and size so that the orifices 93 can penetrate into surface of the packaging means 12 to a minute depth to open the pod, thereby performing the opening process accurately, when the orifices 93 focus on the periphery of the o-ring 20.

The opening means of the opening mechanism includes orifices 93 formed inside of the extracting means 90. The opening of the pod 10 starts when the cavity 91 is closed, and the opening is completed as the cavity 91 is sealed.

When the pod 10 of the present invention has been opened with the penetration of the orifices 93, the orifices 93 of the upper cavity 91 operates as compulsory injection passages for hot water from the boiler mounted at the extraction device, and the orifices 93 of the lower cavity 91 operate as discharge passages of the extracted liquids connected to the outlets.

The opening process of the pod 10 is performed as follows. That is, when the opening process starts after the pod 10 is located inside of the cavity 91 with the moving means, the cavity 91 containing the pod 10 is closed to be sealed, and simultaneously the packaging means 12 of the pod 10 is punched by the orifices 93 arranged inside of the cavity 91 to thereby communicating the injection inlet of the hot water and the discharge outlet of the extracted water with the inside of the pod 10, and performing the automatic opening process.

As the o-ring 20 supports the inner portion of the pod 10 to be sealed by the packaging means 12 tightly, when the orifices 93 penetrate periphery of the inner wall of the o-ring 20, the opening of the pod 10 can be performed very minutely and repeatedly owing to the supporting forces of the o-ring 20.

Accordingly, the cavity 91 is insulated from outside, and as the pod 10 in the cavity 91 is penetrated by the orifices 93, when the hot water is injected into the pod 10, the content 30 is extracted and discharged via the outlet.

Extraction Process Employing the Mechanical Interfacing Means 50

It is necessary to control the pod 10 mechanically with using the mechanically interfacing means 50 formed at side margins 51 of the packaging means 12 so that the pod 10 can produce the same extraction results every time in the exclusive extraction device or in the automatic merchandising machine. The exclusive extraction device or the automatic merchandising machine is designed and provided with several functions and operations to extract the pod 10 mechanically.

As for such functions and operations of the automatic merchandising machine or the exclusive extraction device, the recognition part for sensing the position and the state of the pod 10, recognition mechanism, movement mechanism of the moving part for controlling the position and the movement of the pod 10, opening mechanism of the opening means, and the extracting means 90 and extraction mechanism for extracting the content 30 of the pod 10 can be set forth below.

It is necessary to control the extraction device and the mechanical interfacing means 50 without errors, and the mechanical interfacing means 50 of the pod 10 is arranged regularly at same intervals and of the same types thereby well harmonizing with the extraction device.

For this reason, it is necessary to mechanically interface and convert the pod 10 by defining the mechanical interfacing means 50 regularly at arbitrary positions of the side margins 51 of the pod 10 so that the recognition mechanism of the recognition part can recognize the positions and directions of the pod 10 accurately.

The exclusive extraction device recognizes the positions and directions of the pod 10 accurately and mechanically with employing the mechanical interfacing means 50, which is equipped with the recognition means including a gear or a sensor and the like, thereby locating the pod 10 in its position with respect to the extracting means 90.

Also, the moving part locates the pod 10, which is arranged in order and supplied by a piece, accurately in the cavity 91 of the extracting means 90 using the movement mechanism, preferably hanging with the ring 71. An automatic continuous supplier such as a separate feeder or a magazine can be provided with the extraction device to supply and locate the pod 10 regularly with employing the exclusive extraction device.

The feeder or the magazine can supply the pod 10 in response to the request, which is arranged side by side in the direction to which the slide guides, to the extraction device after they prepare several pods 10 in a predetermined direction. The feeder or the magazine is a device, which stacks the pods 10 and moves them to a transporting means at a certain position and with certain method in response to the request from the transporting means, however, detailed description thereof is abridged as they are not included within the category of the subject invention.

As explained above, it is supposed that the moving mechanism provides proper conditions for the pods, which are supplied regularly, to be extracted by the extraction mechanism so that the pods can be accurately moved to the inner discard position of the cavity 91 in the extracting means 90 and controlled.

Concretely, the pods 10 are loaded and extracted from the first pod 10 to the ‘n’th pod 10 in sequence, according to a method of loading first pod and then extracting it.

The movement mechanism is moved to and fro and rotated, and is made to perform the overall process in sequence repeatedly based on the command from the outside.

When the opening step starts, the cavity 91 containing the pod 10 is closed to make a sealed state, and the packaging means 12 is punched by the orifices 93 formed in the cavity 91, thereby communicating the injection inlet of the hot water and the discharge outlet of the extracted water, with the inside of the pod 10 making the mechanical opening step performed. As the o-ring 20 supports the pod 10, the packaging means is maintained to be sealed tightly so that the opening of the pod 10 can be minutely performed owing to the supporting power of the o-ring 20, when the orifice 93 penetrates the periphery of the o-ring 20. Accordingly, the cavity 91 is in a sealed state from the outside, and as the pod 10 in the cavity 91 is penetrated by the orifices 93, the content 30 can be extracted and discharged via the discharge outlet to the outside when the hot water is injected into the pod 10.

The extracting means 90 includes a space having size enough to contain the pod 10 in the cavity 91, and the cavity 91 operates to be opened and closed to load and discharge the pod 10.

The extracting means 90 includes a pump for supplying the hot water, which is heated by the separate boiler, to the cavity 91. As the boiler and the pump are not included in the subject invention, the detailed description thereof is abridged.

Water supply openings, which are compulsory orifices 93 for injecting the hot water, are formed at the upper portion of the cavity 91 to supply the hot water and the vapor into the cavity 91, and discharge orifices 93 and a discharge outlet 95 for collecting and discharging the extracted liquids are formed at lower portion of the cavity 91. The discharge orifices 93 and the discharge outlet 95 operate as passages and a hopper for the extracted liquids passing the extracted coffee to the discharge outlet formed at lower portion of the cavity 91.

The extraction mechanism functions to provide the inside of the cavity with watertight conditions to prevent the extracted liquids from leaking. It provides watertight conditions with the cavity 91 after locating the pod 10 in the cavity 91.

When the hot water and vapor are pressurized and injected the into the cavity 91 via the orifices 93, the content 30 packaged in the pod 10 are solved instantly into hot water and vapor and extracted (soak out), and discharged via the discharge outlet 95 formed at lower portion of the cavity 91 to cups and the like arranged outside of the extraction device.

As the outer package shape of the pod 10 is maintained with minimum remainders of the ground coffee (extraction remainders) after the extraction of the content 30, the pod 10 can be easily removed by only moving the pod 10 from the cavity 91 to a discard position at the time of removing. As described above, it is possible to maintain good sanitary conditions in the periphery of the extraction device, owing to the simple extracting and removing mechanism.

The extraction mechanism returns to the standby position, which is a reset and initial position, to wait for the next command after accomplishing all the extraction process.

As described above, it is necessary to be provided with identical extraction mechanism and extraction process using same to extract the content 30 of the pod 10 with mechanically interfacing means 50 formed at side margins 51 thereof repeatedly.

Materials to be Potentially Packaged in the Pod

In the pod 10, such foods can be packaged as are extractible and reducible with vapor and the hot water and can be solved into water. For example, roasted and ground coffee can be indicated for the above mentioned foods, and the present invention is suitable for the extraction of them.

The pod 10 can be used for the coffee pod packaging the fore-mentioned roasted and ground coffee, however, soluble coffees, coffee mixed drinks, teas, chocolates, dewatered or enriched food materials, wheat powders, replacing foods, milks, soft milks, powdered milks, foods for weaning a baby from its mother and the like can be packaged in the pod 10.

One of the very important features of pod 10 is that it is distributed in the market in the sealed state till it is opened by the user after the content 30 is packaged by the manufactures. This is a very important advantageous feature that can provide the pod 10 with another actions and functions.

Medicines or functional materials and the like can be packaged in tablets, powders or capsules. When they have been used for a long time, it will be inconvenient for the users to use them continuously and be reluctant to repeated use.

Especially, the pods 10 are very useful for the drinking of the functional materials, or for the drinking of the medicines, or as carriers of components having particular effects.

In case of the materials extractable with the hot water, coffee or tea can be packaged in one pod 10 to make them extracted and enjoyed as drinks under comfortable circumstances. In this case, the user can easily enjoy it as usual drinks rather than medicines.

Such materials are listed as follows: that is, herb tea extracts and concentrates thereof such as an arrowroot herb tea, a herb medicine for harmonizing human body, a complete herb medicine complementing human body, an infusion made of four herb materials, which have special effects widely utilized. Further, such materials include natural materials and concentrates thereof, which have special effects, such as a ginseng, a phellinus, an acantopanax, a hub, a paecilomyces japonica, a silkworm, a ganoderma lucidum, a hovenia dulcis thunberg, a licorice, a jujube, a fruit of a Chinese matrimony vine, an eucommia ulmoides oliver, a cnidium officinale, an angelica gigas, a deer antlers, a yellow flag, a cinnamon, a ginger, a peony, an atractylodes macrocephala, a ginko leaf and the like.

Effective components of the fore-mentioned materials can be extracted previously to thereby being concentrated in soluble tablets or converted to materials soluble to water, then they are packaged in the pod 10 with drink components so as to be taken as beverages, if it is necessary to be extracted.

Hereinafter, the opening and extracting mechanism of the pod 10 are explained concretely in the following examples.

### EXAMPLE 1

Sequential extraction of the pod 10 is performed as follows.

First step: as shown in FIGS. 3a and 3b, the pods 10 move into the cavity 91 sequentially.

Second step: as shown in FIGS. 3a and 3b, the cavity 91 in which the pod 10 is contained is closed.

Third step: as shown in FIG. 4b, the cavity 91 is insulated to provide a sealed and closed state, and the pod 10 is punched and opened at the same time.

Fourth step: as shown in FIG. 4b, the hot water supplied from the boiler and the like is injected into the pod 10 via the orifices 93 so that the content 30 can be extracted to make the extracted liquids and discharged to the outlet via the orifice 93 located at lower portion of the pod.

### EXAMPLE 2

When the several pods 10 are extracted continuously, the extraction steps are performed as follows.

First standby step: the recognition mechanism senses the condition and existence of the first pod 10 under the initial condition that several pods 10 are aligned in order, the pods 10 are standby for the extraction command.

Second cut step: on receiving the extraction command, the extraction device cuts the tear off line 55 formed between the first and second pods 10 from the aligned several pods 10 so that the pods 10 can move to the extracting means 90, after sensing the conditions of the pods 10 by the recognition mechanism.

Third moving step: with the mechanical interfacing means 30 provided at side margins 51 of the pod 10, especially the recognition mechanism counting the number of the recognition holes 53b, the moving mechanism makes the engaging holes 53a to be engaged with the ring 71 to thereby moving the pod 10 to the accurate extraction position along the slide 73 or the rotation shaft 75.

Fourth loading step: the pods 10 are loaded into the cavity 91, and the cavity is closed as explained in example 1.

Fifth punch (opening) step: as shown in FIG. 4b, the cavity 91 is insulated to provide a sealed and closed state of the extraction device, and the pods 10 are punched and opened at the same time.

Sixth extraction step: the pods 10 are located at the accurate extraction position of the device, and then the cavity 91 is sealed tightly by the extraction mechanism, then the hot water and vapor is injected into the cavity 91 with pressure to thereby solving and extracting (soaking out) the content 30 packaged in the pod 10 instantly with the hot water and vapor injected via the orifices 93. As a result, the extracted liquids can be discharged from the outlet 95 provided at lower portion of the cavity 91 to the cup and the like arranged at outside.

Seventh discharge step: after the extraction of the content 30, the packaging shape of the pod 10 is maintained with minimum extraction remainders, especially with ground coffee remainders, and removed easily by means of locating the pod 10 from the cavity 91 to the discard position, and the surrounding portion of the extraction device can be maintained sanitarily clean.

Eighth reset and standby step: when all the extraction processes have been accomplished, the extraction device is returned to its initial standby position and is waiting for next extraction command.

Further, it can be easily understood by those skilled in the art that, a variety of natural or synthesized materials can be packaged as functional materials in the pod 10 so that they can be utilized as beverages and commodities by the users.

### INDUSTRIAL APPLICABILITY

As stated above, according to the pod of the present invention with o-ring inserted between two sheets of the packaging means and provided with mechanical interfacing means at side margins, several advantageous effects can be accomplished.

Especially, when the subject invention is applied to the design of the automatic devices, the design and manufacture of the automatic extracting device are easy and a very simple and accurate extraction system for coffee can be provided because the pod of identical standard will be employed in packaging, transporting, opening and extracting of the pod.

Another advantageous effect of the present invention is to package several soluble extracts including the coffee with ease and quite simple.

Further, the extraction device can also be produced simply at low cost, in contrast to the conventional high cost extraction device.

In addition, if the coffee is packaged in predetermined volume and extracted under identical temperature and pressure and identical time condition, uniform flavors and tastes of the coffee can be always obtained.

Also, according to the present invention, a new market for the instant foods, which can be extracted by hot water and vapor, and a method for simply depositing and preparing instant foods can be introduced for the first time.

Further, the extraction system of the pod of the present invention can be employed conveniently for house use, office use and in automatic merchandising machine. In addition, it is easily understood by those skilled in the relevant art that the present invention can be diversely modified.

1. A pod for packaging content such as foods, coffee, Chinese medicines, and the like, the pod comprising:
two sheets of packaging means for wrapping content with upper and lower portions thereof, said content being formed to be tablet shape, side margins packaging the content to be wrapped at upper and lower portions to each other thereby defining three-dimensional shape of the content and structure of the pod, and
mechanical interfacing means formed at side margins of the packaging means for sensing state of the pod and transport it.

2. A pod for packaging content such as foods, coffee, Chinese medicines, and the like, the pod comprising:
two sheets of packaging means for wrapping content with upper and lower portions thereof, said content being formed to be tablet shape,
an o-ring inserted and arranged between the two sheets of packaging means wrapping upper and lower portions and for containing content inside space thereof;
side margins formed at the packaging means wrapping the o-ring in which the content is contained by interconnecting upper and lower portions thereof, and defining three-dimensional shape of the content and structure of the pod, and mechanical interfacing means formed at side margins of the packaging means for sensing state of the pod or transporting it.

3. The pod of claim 1, wherein the mechanical interfacing means is constructed by including at least one selected from the following elements formed at side margins of the packaging means;
punching regularly,
attaching ring regularly,
making regular folds,
forming regular recesses,
attaching magnetic chips regularly, which may be read by a reader,
attaching magnetic tapes regularly, which may be read by a reader,
attaching magnetic bands regularly, which may be read by a reader,
printing and marking with magnetic inks, which may be read by a reader,
attaching semiconductor chips regularly, which may be read by a reader, and
attaching function button regularly, which may be read by a reader.

4. The pod of claim 1, wherein a cutting line or a tear off line is formed at connection portion of the several pods aligned side by side through cutting a part of the packaging means to be linear or hemi-spherical shape, so that pods can be detached easily by pulling them from each other with small forces.

5. The pod of claim 1, wherein the packaging means is made of materials selected from resins, the glass transition temperature or softening temperature of which is above the boiling temperature of 100 C, selected from a group consisting of plastic materials such as LDPE (low density polyethylene), HDPE (high density polyethylene), PP (polypropylene), PS (polystyrene), ABS resin, PC (polycarbonate), polyester, PET complex resin, EVOH (ethylene vinyl alcohol), PVDC (polyvinylidene chloride) and the like or multi-layer complex sheets including metallic thin film (aluminum, stainless and the like)/plastic.

6. An extraction method for the pod containing such as foods, coffee, Chinese medicines, and the like, the method comprising the steps of:
standing by an extraction command after sensing first pod from several pods aligned side by side in sequence;
cutting a cutting line formed between the first and second pods based on the extraction command;
moving the cut pod to an extraction position along a slide or a rotation shaft by hanging rings into engaging holes formed at transporting means with the mechanical interfacing means counting the number of the recognition holes;
loading the pod by closing a cavity containing the pod;
opening the pod received in the cavity by means of an orifice;
extracting the content of the pod by injecting hot water or vapor through the orifice and solving the content to discharge via discharge outlet; and
discharging the extracted pod after moving to a discard position from the cavity after extraction of the content.

7. An extraction device of a pod packaging contents such as foods, coffee, Chinese medicines, and the like, by means of a mechanical interfacing means, the device comprising:
transporting means for moving several pods connected continuously and containing content to an extraction position; and
extracting means for extracting content contained in the pod moved to the extraction position.

8. The pod of claim 2, wherein the mechanical interfacing means is constructed by including at least one selected from the following elements formed at side margins of the packaging means;
punching regularly,
attaching ring regularly,
making regular folds,
forming regular recesses,
attaching magnetic chips regularly, which may be read by a reader,
attaching magnetic tapes regularly, which may be read by a reader,
attaching magnetic bands regularly, which may be read by a reader,
printing and marking with magnetic inks, which may be read by a reader,
attaching semiconductor chips regularly, which may be read by a reader, and
attaching function button regularly, which may be read by a reader.

9. The pod of claim 2, wherein a cutting line or a tear off line is formed at connection portion of the several pods aligned side by side through cutting a part of the packaging means to be linear or hemi-spherical shape, so that pods can be detached easily by pulling them from each other with small forces.

10. The pod of claim 2, wherein the packaging means is made of materials selected from resins, the glass transition temperature or softening temperature of which is above the boiling temperature of 100 C, selected from a group consisting of plastic materials such as LDPE (low density polyethylene), HDPE (high density polyethylene), PP (polypropylene), PS (polystyrene), ABS resin, PC (polycarbonate), polyester, PET complex resin, EVOH (ethylene vinyl alcohol), PVDC (polyvinylidene chloride) and the like or multi-layer complex sheets including metallic thin film (aluminum, stainless and the like)/plastic.
